(19) United States
(12) Patent Application Publication
(10) Pub. No.: US 2016/0037265 A1
(43) Pub. Date: Feb. 4, 2016

(54) ZERO OR LOW POWER MEMS MICROPHONE

(71) Applicant: Invensense, Inc., San Jose, CA (US)

(72) Inventor: Aleksey S. Khenkin, Nashua, NH (US)

(21) Appl. No.: 14/447,012

(22) Filed: Jul. 30, 2014

(51) Int. Cl. H04R 19/04

(52) U.S. Cl. CPC H04R 19/04; H04R 2201/003

(57) ABSTRACT

Membrane, coil, and magnet configurations for MEMS microphones are provided to minimize or eliminate power consumption by the MEMS microphones. In a microphone, a membrane can be associated with or connected to a coil, wherein the coil can be situated around a permanent magnet. The membrane can be suspended by a set of springs. In one arrangement, the coil can be embedded in the membrane and the magnet can be situated underneath the membrane and coil structure within the microphone. In another arrangement, the magnet can comprise a set of magnet sections, and a membrane and coil structure, wherein the membrane and coil structure can have the coil portion embedded with the membrane portion, and the membrane and coil structure can be situated in proximity to the base of the magnet, and in between respective poles of respective magnet sections, within the microphone.

### TECHNICAL FIELD

The subject disclosure relates generally to microphone-related technologies, e.g., for zero or low power microelectrical-mechanical systems (MEMS) microphones.

### BACKGROUND

A microphone is a device that can facilitate converting sound (e.g., acoustic waves) to electrical signals that can be transmitted, processed and/or amplified to facilitate presentation of the audio (e.g., transmission of the audio, via electronic signals, to another electronic device for presentation, transmission of the electronic signals to a set of speakers that can convert the electronic signals to audio sound for presentation). There are various types of microphones that can be used for a variety of types of applications and/or in a variety of types of electronic devices. Microphones can be used as a stand-alone device, for example, by singers while singing on stage or speakers while giving speeches. Microphones also can be employed in electronic devices, such as, for example, telephones (e.g., mobile phones, landline phones), computers, electronic pads or tablets, electronic games, or audio and/or video recording devices, to facilitate receiving and processing voice or other audio sounds.

One type of microphone is a dynamic microphone. Conventional dynamic microphones are passive devices and consume no or zero power. Another type of microphone is a condenser microphone. A typical condenser microphone can provide better performance than a dynamic microphone, as the sound quality of a dynamic microphone is typically not as good as the sound quality of a condenser microphone. However, conventional condenser microphones typically can require external power in order to operate and/or can be relatively higher in cost, as compared to conventional dynamic microphones.

The above-described description is merely intended to provide a contextual overview relating to microphones, and is not intended to be exhaustive.

### SUMMARY

The following presents a simplified summary of various aspects of the disclosed subject matter in order to provide a basic understanding of some aspects described herein. This summary is not an extensive overview of the disclosed subject matter. It is intended to neither identify key or critical elements of the disclosed subject matter nor delineate the scope of such aspects. Its sole purpose is to present some concepts of the disclosed subject matter in a simplified form as a prelude to the more detailed description that is presented later.

One or more embodiments, such as one or more devices, methods, integrated circuits, and techniques disclosed herein, relate to microphones, such as microphones that can operate without consuming power. Disclosed herein is a device comprising a microelectrical-mechanical systems (MEMS) membrane; a coil associated with the MEMS membrane; and a magnet configured to be located in proximity to the MEMS membrane and the coil, wherein the magnet is configured to generate a magnetic field and the coil is located within the magnetic field, and wherein acoustic waves received by the device cause the MEMS membrane to vibrate, accordingly causing the coil to move in relation to the magnet resulting in generation of electrical signals that correspond to the acoustic waves.

Also disclosed herein is a method that comprises associating a MEMS diaphragm with a coil. The method also comprises configuring a magnet to be located within a defined distance of the MEMS diaphragm and the coil, wherein the magnet generates a magnetic field and the coil is located within the magnetic field, and wherein, in response to acoustic waves sensed by the MEMS diaphragm, the MEMS diaphragm vibrates, and, in response to the vibration of the MEMS diaphragm, the coil moves in relation to the magnet resulting in generating of electrical signals that correspond to the acoustic waves.

Further disclosed herein is an integrated circuit chip. The integrated circuit chip comprises a MEMS sensor element. The integrated circuit chip also comprises a coil component associated with the MEMS sensor element. The integrated circuit chip further comprises a magnet component that is located in proximity to the MEMS sensor element and the coil component, wherein the magnet component generates a magnetic field and the coil component is located within the magnetic field, and wherein the MEMS sensor element moves in response to audio waves received by a device comprising the integrated circuit chip, and, in response to the movement of the MEMS sensor element, the coil moves in relation to the magnet resulting in generation of electrical signals that correspond to the audio waves.

The following description and the annexed drawings set forth in detail certain illustrative aspects of the disclosed subject matter. These aspects are indicative, however, of but a few of the various ways in which the principles of the disclosed subject matter may be employed, and the disclosed subject matter is intended to include all such aspects and their equivalents. Other advantages and distinctive features of the disclosed subject matter will become apparent from the following detailed description of the disclosed subject matter when considered in conjunction with the drawings.

### BRIEF DESCRIPTION OF THE DRAWINGS

FIG. 1 illustrates a block diagram of an example device, in accordance with various aspects and embodiments of the disclosed subject matter.

FIG. 2 depicts a diagram of a cross-sectional side-view of a portion of an example device that employs a membrane (e.g., MEMS membrane) associated with a coil, in accordance with various aspects and embodiments of the disclosed subject matter.

FIG. 3 depicts a diagram of a top view of a portion of the example device, in accordance with various aspects and embodiments of the disclosed subject matter.

FIG. 4 illustrates a diagram of a cross-sectional side-view of a portion of another example device that employs a membrane (e.g., MEMS membrane) associated with a coil, in accordance with various aspects and embodiments of the disclosed subject matter.

FIG. 5 depicts a diagram of a cross-sectional side-view of a portion of another example device that employs a membrane (e.g., MEMS membrane) associated with a coil and comprising a hole to accommodate a magnet that can be positioned within the hole, in accordance with various aspects and embodiments of the disclosed subject matter.

FIG. 6 illustrates a diagram of a top view of a portion of the example device, in accordance with various aspects and embodiments of the disclosed subject matter.

FIG. 7 depicts a diagram of an enlarged view of a portion of the side-view cross-section of the example device, in accordance with various aspects and embodiments of the disclosed subject matter.

FIG. 8 illustrates a diagram of a cross-sectional side-view of a portion of an example device that employs a membrane (e.g., MEMS membrane) associated with a coil and comprising a hole to accommodate a magnet that can be positioned within the hole, wherein the magnet comprises multiple magnet sections, in accordance with various aspects and embodiments of the disclosed subject matter.

FIG. 9 depicts a diagram of a top view of a portion of the example device, in accordance with various aspects and embodiments of the disclosed subject matter.

FIG. 10 illustrates a block diagram of still another example device, in accordance with various aspects and embodiments of the disclosed subject matter.

FIG. 11 illustrates a flow diagram of an example method for constructing a microphone that can operate while consuming no power, in accordance with various aspects and embodiments of the disclosed subject matter.

FIG. 12 depicts a flow diagram of another example method for constructing a microphone that can operate while consuming no power, in accordance with various aspects and embodiments of the disclosed subject matter.

### DETAILED DESCRIPTION

The disclosed subject matter is described with reference to the drawings, wherein like reference numerals are used to refer to like elements throughout. In the following description, for purposes of explanation, numerous specific details are set forth in order to provide a thorough understanding of the various embodiments of the subject disclosure. It may be evident, however, that the disclosed subject matter may be practiced without these specific details. In other instances, well-known structures and devices are shown in block diagram form in order to facilitate describing the various embodiments herein.

In the described embodiments, an integrated circuit (IC) substrate can refer to a silicon substrate with electrical circuits, typically complementary metal-oxide-semiconductor (CMOS) circuits. Also, a CMOS IC substrate can include an application-specific integrated-circuit (ASIC). A cavity can refer to a recess in a substrate, a lid (cover), or a casing. An enclosure can refer to a fully enclosed or substantially fully enclosed volume typically surrounding a microelectrical-mechanical systems (MEMS) structure and typically formed by the IC substrate, a structural layer, a MEMS substrate, and/or other components or structures. A port can be an opening through a substrate to expose the MEMS structure to the surrounding environment. It is to be appreciated that an enclosure can include an acoustic port, in various embodiments of the subject disclosure.

In the described embodiments, a chip can include at least one substrate that typically can be formed from a semiconductor material. A single chip can be formed from multiple substrates, where the substrates can be mechanically bonded to preserve functionality. Multiple chips can include at least two substrates, wherein the two substrates can be electrically connected, but do not require mechanical bonding. A package or casing can provide electrical connection between the bond pads on the chip to a metal pad that can be soldered to a printed circuit board (PCB). A package typically can comprise a substrate and a cover. It is to be appreciated that the package can hermitically seal its components, with the exception that the port opening of the package can allow for air flow in and out of the package. Also, it is to be appreciated that the package can provides an acoustic seal, with the exception that the port opening of the package can allow for sound waves to enter and exit the package.

In the described embodiments, a cavity can refer to an opening or recession in a substrate wafer and enclosure can refer to a fully or substantially fully enclosed space that can include a port opening. In various aspects of the subject disclosure, a cavity or back cavity can provide acoustic sealing, with the exception that it can allow sound waves to enter and exit by way of a membrane (e.g. a MEMS membrane, diaphragm, or sensor element), and/or an acoustic leakage path. In some embodiments, a back cavity also can be referred to as a back chamber. A back cavity formed within the CMOS-MEMS device can be referred to as an integrated back cavity.

In, for example, live applications (e.g., on stage), vocalists typically use dynamic microphones when singing, with the audio signal from the dynamic microphone being communicated to a sound system for broadcast to the audience. Conventional dynamic microphones are passive devices and consume no or zero power. Structurally, a conventional dynamic microphone can include a permanent magnet and a coil that can surround, or be located near, the magnet. The coil can be attached to a membrane that can be subjected to sound pressure, e.g., as a vocalist sings, or as other audio sounds are projected, into the microphone. A dynamic microphone also can include a passive resistor-capacitor (RC) circuit that can precede a preamplifier stage of the dynamic microphone. When the membrane is subject to sound pressure, the sound pressure can cause the membrane to move. In turn, the coil attached to the membrane can move in relation to the magnet, which in turn can generate electric current. The preamplifier can pick up (e.g., receive) the electric current, wherein the preamplifier can facilitate processing (e.g., amplifying or increasing) the level of the signal to line level (e.g., a desired signal strength that can be usable by mixing consoles, recording devices, and other audio equipment).

The impedance of a dynamic microphone typically can range from, e.g., 400 ohms to 1000 ohms, which can be low enough to drive a relatively long cable. Also, dynamic microphones can be relatively inexpensive, robust, and reliable. As a result, dynamic microphones can be quite suitable for live applications (e.g., music concerts or other live events involving the use of microphones and sound systems).

Another type of microphone is a condenser microphone. A typical condenser microphone can provide better performance than a dynamic microphone, as the sound quality of a dynamic microphone is typically not as good as the sound quality of a condenser microphone. However, conventional condenser microphones can require external power in order to operate and/or can be relatively higher in cost, as compared to conventional dynamic microphones.

A conventional type of condenser microphone can include a diaphragm that can operate as one plate of a capacitor and, while at rest, can be within a defined distance of the other plate of the capacitor. As the diaphragm is subject to sound pressure, e.g., from vocal sounds or other sounds, the diaphragm can move or vibrate in relation to the other plate, which can change the distance between the plates. As the plates can be biased with a fixed charge, the capacitance of the plates can vary as the distance between the plates varies, which can facilitate electrically generating an audio signal. A condenser microphone also can have a preamplifier. However, the impedance of a condenser microphone typically can be relatively high, e.g., several gigaohms, in the audio band such that, for desirable operation and performance, the capsule or condenser portion of the microphone typically cannot be directly connected to the preamplifier. A buffer amplifier can precede the preamplifier stage of the signal processing (e.g., a buffer amplifier can be positioned between the capsule or condenser portion of the microphone and the preamplifier) to facilitate more desirable operation and performance of the condenser microphone.

Typically, at least some current is employed to operate the buffer amplifier. Also, certain conventional condenser microphones (e.g., a direct current (DC)-biased condenser microphone, a radio frequency (RF) or high frequency (HF) condenser microphone, a MEMS condenser microphone) typically can require external power (e.g., an external voltage source), which can be applied, e.g., to the diaphragm, in order for the condenser microphone to operate properly. The external voltage source can be a power supply, phantom power (e.g., DC power transmitted via a microphone cable connected to the condenser microphone for use in powering the condenser microphone), or a battery, for example.

Another type of condenser microphone is an electret condenser microphone. A conventional electret condenser microphone can include a film (e.g., teflon film) that can have dielectric properties, wherein the film can be charged such that, after being charged, it can maintain a quasi-permanent electric charge and can act in a manner similar to a permanent magnet. This film, having the quasi-permanent charge, can create an electric field inside the electret condenser microphone typically without the need for an external voltage source to produce such electric field to facilitate operation of the electret condenser microphone.

Still another type of condenser microphone is a MEMS microphone, which also can be referred to as a silicon microphone. In a conventional MEMS microphone (e.g., conventional MEMS condenser microphone), during the fabrication process, a pressure-sensitive diaphragm can be etched into a silicon chip using MEMS techniques (e.g., MEMS or CMOS MEMS semiconductor fabrication processes). A conventional MEMS microphone also can include a preamplifier as well as a charge pump or other type of voltage source, or can be connected to a voltage source, that can provide power to the microphone to facilitate operation of the microphone.

Systems, methods, devices, and techniques for constructing, configuring, and implementing microphones (e.g., MEMS microphones) that utilize (e.g., consume) no (e.g., zero) power, or at least reduced or minimal power, are presented. In accordance with various implementations, membrane, coil, and magnet configurations in microphones are provided to minimize or eliminate power consumption by such microphones. In some implementations, a microphone can be a MEMS microphone.

In certain implementations, a microphone (e.g., a MEMS microphone) can be constructed to comprise a membrane (e.g., a MEMS membrane, diaphragm, or sensor element) that can be associated with (e.g., connected to, attached to, integrated with, structured with or to include (e.g., embed)) a coil (e.g., an induction coil), or a portion thereof, wherein the coil can be associated with (e.g., situated or positioned around or in relation to (e.g., in proximity to)) a magnet (e.g., a permanent magnet). The membrane and/or associated coil (e.g., the membrane and/or coil structure) can be formed on a semiconductor die (e.g., silicon die or chip), for example, using MEMS techniques. The membrane also can be associated with (e.g., connected to and/or suspended by) a set of springs or another type of suspension component.

In certain implementations, the coil, or at least a portion thereof, can be embedded in the membrane to form a membrane and coil structure, and the magnet can be situated underneath or above, and in proximity to (e.g., within a defined distance of), the membrane and coil structure, within the microphone, such that the coil can be within the magnetic field of the magnet. In other implementations, the coil, or at least a portion thereof, can be embedded in the membrane to form a membrane and coil structure, wherein the membrane can comprise a hole of a defined size and shape in the middle of the membrane to facilitate enabling at least a portion of a magnet to be positioned within the hole in the membrane and surrounded by the coil.

In still other implementations, a microphone (e.g., a MEMS microphone) can be constructed to comprise a magnet that can comprise a set of magnet sections, and a membrane and coil structure. The membrane and coil structure can have the coil portion embedded with the membrane portion. The membrane and coil structure can be situated above the base of the magnet, and respective portions of the membrane and coil structure can be situated in between respective poles (e.g., north pole, south pole) of respective magnet sections of the set of magnet sections, within the microphone.

In accordance with various aspects and embodiments of the disclosed subject matter, when a microphone (e.g., a MEMS microphone) is subject to audio waves (e.g., from a person's voice or other sound), the membrane can be subject to (e.g., be impacted by) the audio waves (e.g., acoustic waves), and in response, the membrane can vibrate in a manner that corresponds to the audio waves. Since the coil is associated with the membrane, the coil can correspondingly move in response to the vibration of the membrane. The magnet or magnet portions, which can be in proximity to the coil, can be in a fixed position within the microphone. As the coil moves, in response to the vibration of the membrane, and in relation to the magnetic field of the magnet or magnet portions, electrical signals can be generated by the coil, wherein the electrical signals can correspond to or represent the audio waves received by the microphone. Thus, the microphone can convert audio waves into electrical signals that can correspond to the audio waves received by the microphone, wherein the electrical signals can be transmitted, amplified, and/or otherwise processed.

In contrast to conventional condenser microphones (e.g., conventional MEMS condenser microphones), in accordance with the disclosed subject matter, a microphone (e.g., a MEMS microphone) can operate suitably without consuming or needing power, and it is not necessary for such microphone to have a charge pump (e.g., on the semiconductor device) or other external power source in order for the microphone to operate in a desirable or suitable manner. In accordance with various other implementations and embodiments, as desired, a microphone also can comprise one or more other components, such as, for example, a preamplifier, a filter, or an analog-to-digital converter, as more fully disclosed herein. In implementations of the disclosed subject matter wherein a MEMS microphone includes a preamplifier, an active or a digital filter, or an analog-to-digital converter, the MEMS microphone still can operate desirably or suitably, while consuming less power than conventional condenser microphones, due in part to the power-free operation associated with the magnet and the membrane and coil structure, even though such preamplifier, active or digital filter, or analog-to-digital converter may require a certain amount of power for operation.

These and other aspects of the disclosed subject matter are described with regard to the figures.

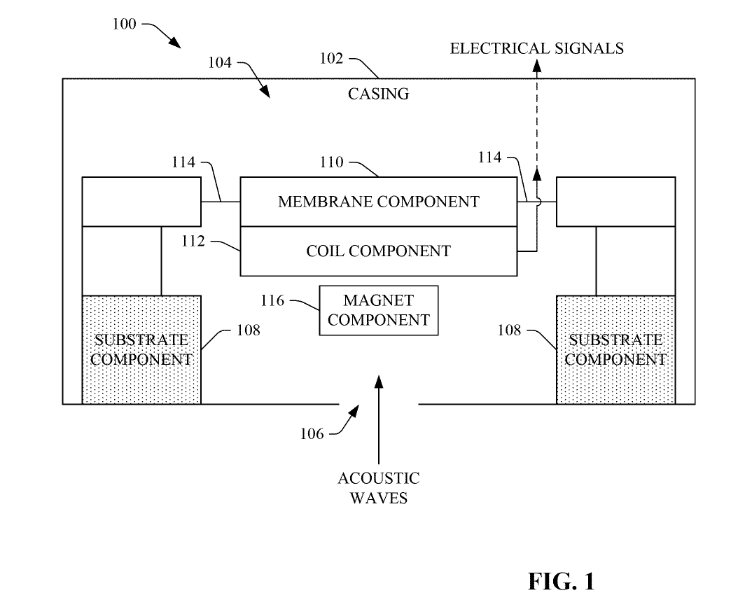

Turning to FIG. 1, illustrated is a block diagram of an example device 100 (e.g., a microphone), in accordance with various aspects and embodiments of the disclosed subject matter. In an aspect, the device 100 can comprise a case component 102 that can comprise a casing or package that can be constructed out of one or more desired materials (e.g., plastic, metal). The case component 102 can comprise a cavity 104 of a desired size and shape in which various components of the device 100 can be placed. A hole component 106 can comprise one or more holes (e.g., acoustic port) of a desired size(s) and shape(s) that can be formed in the case component 102, wherein the hole component 106 can enable audio waves (e.g., from voice or other sounds) to travel from the outside of the case component 102 into the case component 102 for processing by the device 100.

The device 100 can include a substrate component 108 (e.g., an integrated circuit (IC) substrate) that can be part of or formed from a semiconductor (e.g., silicon) chip or die. The device 100 also can comprise a membrane component 110 that can comprise a membrane (e.g., an acoustic MEMS membrane, diaphragm, or sensor element) that can be formed on the semiconductor chip or die using desired techniques (e.g., MEMS and/or desired semiconductor device fabrication techniques). In some implementations, the device 100 can be a silicon on insulator (SOI)-based device, wherein the device 100 can be produced or fabricated using SOI technology and techniques (e.g., the substrate component 108 can comprise a layered silicon-insulator-silicon substrate), which can facilitate reducing parasitic capacitance in the device 100 and can improve performance of the device 100.

The device 100 can comprise a coil component 112 that can comprise a coil (e.g., induction coil) of defined size, length, and thickness (e.g., based on diameter or width) and having a defined number of coil windings. The coil (e.g., induction coil) can be formed to comprise a desired conductive material (e.g., a metal). In accordance with various implementations, the coil component 112 can be associated with the membrane component 110, wherein, for example, the coil of the coil component 112 can be embedded in, integrated with, formed or structured on, connected or attached to, or otherwise associated with, the membrane of the membrane component 110, e.g., using desired techniques (e.g., MEMS and/or semiconductor device fabrication techniques), which can form a membrane and coil structure (e.g., an integrated membrane and coil structure).

The device 100 also can comprise a suspension component 114 that can be associated with (e.g., connected or attached to) the membrane component 110, and can be associated with (e.g., connected or attached to) the substrate component 108 or other component(s) associated with the semiconductor chip. For instance, the suspension component 114 can comprise a set of springs or other suspension sub-components that can be attached to two or more (e.g., four) areas (e.g., sides) of the membrane to facilitate suspending or holding the membrane within a defined distance of a magnet component 116 when the membrane of the membrane component 110 is at rest (e.g., is not moving or being subjected to audio waves), while the set of springs or other suspension sub-components also can have a desired amount of flexibility to enable the membrane of the membrane component 110 to vibrate and/or move in relation to (e.g., vary in distance from) the magnet component 116, in response to the membrane being subjected to audio waves received by the device 100.

The magnet component 116 can comprise one or more magnets (e.g., permanent magnets) or one or more magnet sections that can be placed in proximity to (e.g., within a defined distance of) the membrane component 110 and coil component 112 such that the coil component 112 can be within the magnet field generated by the one or more magnets or magnet sections and spanning out across a defined area that can be based at least in part on the magnetic strength and direction of the magnet component 116. A magnet or magnet section of the magnet component 116 can comprise, for example, two opposite poles, such as a north pole and a south pole. In some implementations, the magnet component 116 can include a base portion of a magnet that can be associated with (e.g., attached to or integrated with) multiple magnet sections, wherein each magnet section can comprise two opposite poles (e.g., a north pole and a south pole).

In certain implementations, the membrane of the membrane component 110 can comprise a hole of a defined size and shape in the middle (e.g., at or near the center) of the membrane to facilitate enabling at least a portion of a magnet or magnet section of the magnet component 116 to be positioned within the hole formed in the membrane and surrounded by the coil of the coil component 112. In response to being subjected to acoustic waves (e.g., audio waves), the membrane of the membrane component 110 and associated coil of the coil component 112 can vibrate or move in relation to the magnet or magnet section of the magnet component 116 that is positioned within the hole formed in the membrane (e.g., the membrane and associated coil can vibrate or move up and down with respect to the shaft of the magnet or magnet portion).

In accordance with various aspects and embodiments of the disclosed subject matter, when the device 100 is subject to acoustic waves (e.g., from a person's voice or other sound) via the hole component 106 of the device 100, the membrane of the membrane component 110 can be subjected to (e.g., be impacted by) the acoustic waves, and, in response, the membrane can vibrate or move in a manner that can correspond to the acoustic waves. Since the coil of the coil component 112 is associated with the membrane of the membrane component 110, the coil can correspondingly move in response to the vibration of the membrane. The magnet or magnet portions of the magnet component 116, which can be in proximity to the coil, can be in a fixed position within the device 110. As the coil moves, in response to the vibration of the membrane, and in relation to the magnetic field of the magnet or magnet portions, current in the coil can vary through electromagnetic induction, and, in response to the varying current, electrical signals can be generated by the coil of the coil component 112, wherein the electrical signals can correspond to or represent the acoustic waves received by the device 100. As a result, the device 100 (e.g., MEMS microphone) can convert acoustic waves (e.g., audio waves) into electrical signals that can correspond to the acoustic waves received by the device 100. The electrical signals generated by the device 100 can be transmitted, amplified, and/or otherwise processed, as desired.

In contrast to conventional MEMS condenser microphones or other powered microphones, in accordance with the disclosed subject matter, the devices (e.g., MEMS microphones) disclosed herein can operate suitably without consuming or needing power, and without the need for such devices to have a charge pump (e.g., on the semiconductor device) or other external power source in order for the devices to operate in a desirable or suitable manner. Another advantage of the disclosed subject matter is that, by associating (e.g., embedding, integrating, forming or structuring, connecting or attaching, or otherwise associating with) the coil of the coil component 112 with (or in, on, or to) the membrane (e.g., MEMS membrane) of the membrane component 110, the coil can reinforce the membrane, which can thereby reduce any potential deformation or sagging to the membrane due to inherent stresses on the membrane and improve performance of the device 100.

The devices (e.g., microphones) disclosed herein can be used as a stand-alone device, for example, by singers while singing on stage or speakers while giving speeches. The devices (e.g., microphones) disclosed herein also can be employed in various electronic devices or systems, such as, for example, telephones (e.g., mobile phones, landline phones), computers, electronic pads or tablets, electronic games, audio and/or video recording devices, earbuds comprising a microphone (e.g., for a mobile phone), hearing aids or instruments, security systems, biometric security systems, two-way radios, or public announcement systems, to facilitate receiving and processing voice or other audio sounds. As the devices can operate without consuming power, the devices can be suitable for use as always-on microphones (e.g., always-on MEMS microphones) that can be in an on state and always listening for audio sounds (e.g., via audio waves) all the time (e.g., while communicatively connected) or as desired (e.g., for a desired period of time). The device, when used as an always-on microphone, can be used for waking up a host device (e.g., a computer, a mobile phone, an audio or video recorder, a security device associated with a security system, an electronic pad or tablet, a hearing aid), for example.

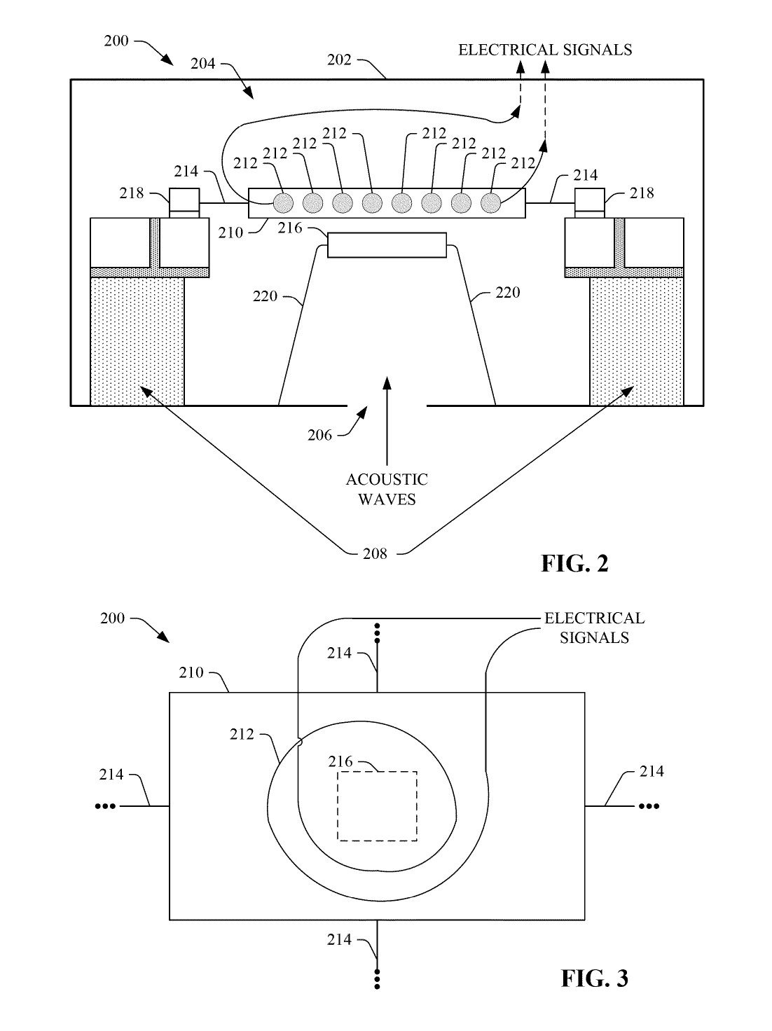

FIG. 2 depicts a diagram of a cross-sectional side-view of a portion of an example device 200 (e.g., a MEMS microphone) that employs a membrane (e.g., MEMS membrane) associated with a coil (e.g., a coil embedded in or integrated with the membrane), and FIG. 3 depicts a diagram of a top view of a portion of the example device 200, in accordance with various aspects and embodiments of the disclosed subject matter. The device 200 can comprise a casing 202, a cavity 204, a hole 206, a substrate 208, a membrane 210, a coil 212, a set of suspension components (e.g., springs) 214, and a magnet 216 that, respectively, can be the same as or similar to, and/or can comprise the same or similar features or functionalities as, respective components (e.g., respectively named components), as more fully disclosed herein.

The coil 212 can be embedded or integrated in the membrane 210 (e.g., an acoustic MEMS membrane, diaphragm, or sensor element), for example, to form a membrane and coil structure. In some implementations, the membrane 210 can be or can comprise, for example, a MEMS membrane (e.g., an acoustic MEMS membrane), diaphragm, or sensor element, wherein the membrane 210 (and/or the associated coil 212) can be formed on the semiconductor chip or die using desired techniques (e.g., MEMS and/or desired semiconductor device fabrication techniques).

It is to be appreciated and understood that the coil 212 can comprise a defined number of windings having a desired arrangement, and FIGS. 2 and 3 depict, in a non-limiting manner, an example coil 212 having an example number of windings and an example coil arrangement for purposes of brevity and clarity. In accordance with the disclosed subject matter, there are a variety of different coils having different numbers of windings and/or different types of coil arrangements that can be employed to form a coil that can be used in the devices disclosed herein.

The membrane 210 can be attached to the set of suspension components 214, wherein for example, an end of each suspension component 214 can be attached to a side or desired portion (e.g., edge portion) of the membrane 210. The other ends of the suspension components 214 can be attached to support components 218 that can be formed on or attached to (e.g., indirectly or directly) the substrate 208 or another portion(s) of the semiconductor die. The support components 218 can be fixed in position on the substrate 208 or other portion(s) of the semiconductor die. The support components 218 can provide suitable support to hold the attached ends of the set of suspension components 214 in place. The set of suspension components 214 can be strong and suitable enough to facilitate suspending or holding the membrane 210 within a defined distance of the magnet 216 when the membrane 210 is at rest (e.g., is not moving or being subjected to audio waves), while the set of suspension components 214 also can have a desired amount of flexibility to enable the membrane 210 to vibrate and/or move in relation to (e.g., vary in distance from) the magnet 216, in response to the membrane 210 being subjected to acoustic waves received by the device 200 (e.g., a MEMS microphone).

In some implementations, the magnet 216 can comprise a permanent magnet that can be placed in proximity to (e.g., within a defined distance of) the membrane 210 and coil 212 such that the coil 212 can be within the magnet field generated by the magnet 216. A permanent magnet is magnet that can retain its magnetic properties in the absence of an inducing field or current. The magnet 216 can be fixed in position by a set of magnet support components 220 that each can have one end attached to the magnet 216 and another end attached to the casing 202 (as depicted), the substrate 208 or another portion(s) of the semiconductor die or the device 200, wherein the set of magnet support components 220 can be strong enough and suitable to hold the magnet 216 in a fixed position within the device 200.

When the device 200 receives acoustic waves via the hole component 206 (e.g., acoustic port), the membrane 210 can be subject to the acoustic waves, and, in response, the membrane 210 and associated coil 212 can vibrate or move in a manner that can correspond to the acoustic waves. As the coil 212 moves, in response to the vibration of the membrane 210, and in relation to the magnetic field of the magnet 216, current in the coil 510 can vary as a result of electromagnetic induction, and, in response to the varying current, electrical signals can be generated by the coil 212, wherein the electrical signals can correspond to or represent the acoustic waves received by the device 200. As a result, the device 200 (e.g., MEMS microphone) can convert the received acoustic waves into electrical signals that can correspond to the acoustic waves received by the device 200. The electrical signals generated by the device 200 can be transmitted, amplified, and/or otherwise processed, as desired.

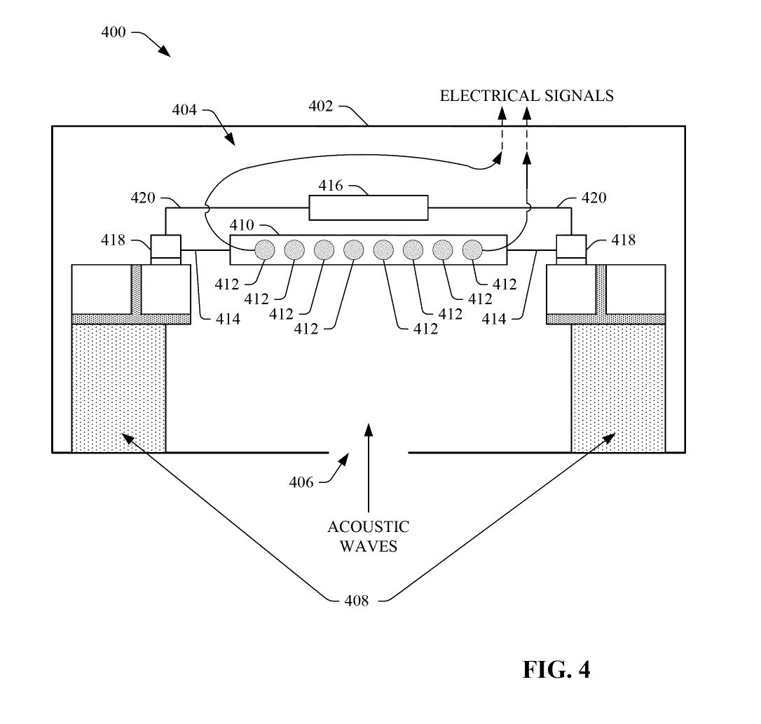

FIG. 4 illustrates a diagram of a cross-sectional side-view of a portion of another example device 400 (e.g., a microphone) that employs a membrane (e.g., MEMS membrane) associated with a coil (e.g., a coil embedded in or integrated with the membrane), in accordance with various aspects and embodiments of the disclosed subject matter. The device 400 can comprise a casing 402, a cavity 404, a hole 406, a substrate 408, a membrane 410, a coil 412, a set of suspension components (e.g., springs) 414, a magnet 416, a set of support components 418, and a set of magnet support components that, respectively, can be the same as or similar to, and/or can comprise the same or similar features or functionalities as, respective components (e.g., respectively named components), as more fully disclosed herein. In some implementations, the membrane 410 can be or can comprise, for example, a MEMS membrane (e.g., an acoustic MEMS membrane), diaphragm, or sensor element, wherein the membrane 410 (and/or the associated coil 412) can be formed on the semiconductor chip or die using desired techniques (e.g., MEMS and/or desired semiconductor device fabrication techniques).

The device 400 (e.g., a MEMS microphone) can be substantially the same as the device 200, except, for example, that the magnet 416 can be on the other side of the membrane 410 and within the cavity 404. The magnet 416 (e.g., permanent magnet) can be placed in proximity to (e.g., within a defined distance of) the membrane 410 and coil 412 such that the coil 412 can be within the magnet field generated by the magnet 416. The magnet 416 can be fixed in position by the set of magnet support components 420 that each can have one end attached to the magnet 416 and another end attached to the support components 418 (as depicted), the casing, or another portion(s) of the semiconductor die or the device 400, wherein the set of magnet support components 420 can be strong enough and suitable to hold the magnet 416 in a fixed position within the device 400. The device 400 can operate in a same or substantially same manner as the device 200, or other devices disclosed herein, in accordance with the disclosed subject matter.

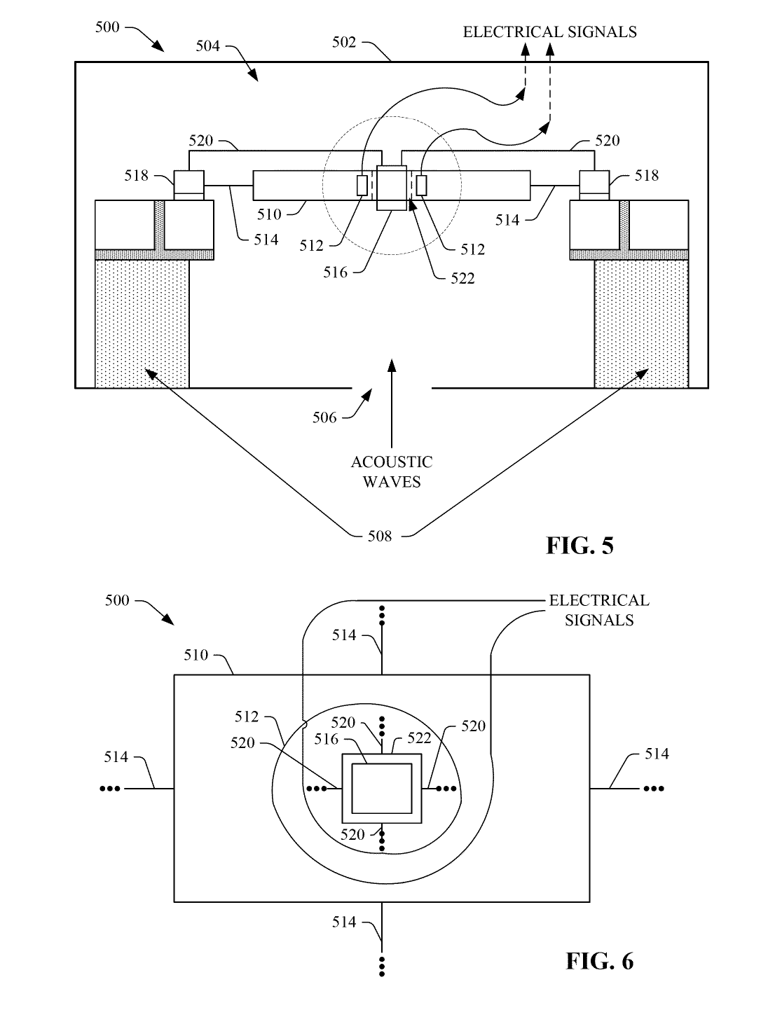

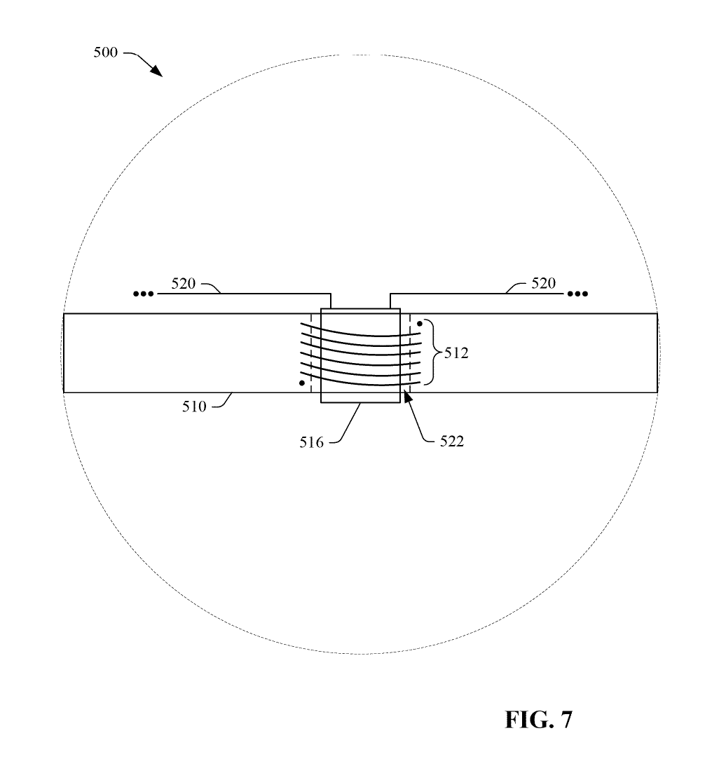

FIG. 5 depicts a diagram of a cross-sectional side-view of a portion of another example device 500 (e.g., a microphone) that employs a membrane (e.g., MEMS membrane) associated with a coil (e.g., a coil embedded in or integrated with the membrane) and comprising a hole to accommodate a magnet that can be positioned within the hole, in accordance with various aspects and embodiments of the disclosed subject matter. FIG. 6 illustrates a diagram of a top view of a portion of the example device 500, and FIG. 7 depicts a diagram of an enlarged view (e.g., a blown-up view) of a portion of the cross-sectional side-view of the example device 500, in accordance with various aspects and embodiments of the disclosed subject matter. The device 500 can comprise a casing 502, a cavity 504, a hole 506, a substrate 508, a membrane 510, a coil 512, a set of suspension components (e.g., springs) 514, a magnet 516, a set of support components 518, and a set of magnet support components 520 that, respectively, can be the same as or similar to, and/or can comprise the same or similar features or functionalities as, respective components (e.g., respectively named components), as more fully disclosed herein. In some implementations, the membrane 510 can be or can comprise, for example, a MEMS membrane (e.g., an acoustic MEMS membrane), diaphragm, or sensor element, wherein the membrane 510 (and/or the associated coil 512) can be formed on the semiconductor chip or die using desired techniques (e.g., MEMS and/or desired semiconductor device fabrication techniques).

The device 500 (e.g., a MEMS microphone) can be substantially the same as the devices (e.g., device 100, device 200, device 400, or other device(s)) disclosed herein, except, for example, with respect to the following. The membrane 510 can be formed to comprise a hole 522 that can have a defined size and shape and can be in the middle (e.g., at or near the center) of the membrane 510 to facilitate enabling at least a portion of a magnet of the magnet 516 to be positioned within the hole 522 formed in the membrane 510 and surrounded by the coil 512 (e.g., surrounded by the windings of the coil 512). The defined size and shape of the hole 522 of the membrane 510, and the location of the hole 522 in the membrane 510, can correspond or at least substantially correspond with the defined size and shape of the magnet 516 and the location of the magnet 516 within the device 500. The membrane 510 can be formed such that there can be a desired space or gap between the edges of the hole 522 of the membrane 510 and the sides of the magnet 516 facing the respective edges of the hole 522 to facilitate enabling the membrane 510, and associated coil 512, to vibrate or move in relation to the magnet 516, in response to acoustic waves received by the device 500, e.g., via the hole 506. The magnet 516 can be fixed in position by the set of magnet support components 520, wherein each of the magnet support components 520 can have one end attached to the magnet 516 and another end attached to the support components 518 (as depicted), the casing 502, or another portion(s) of the semiconductor die or the device 500, wherein the set of magnet support components 520 can be strong enough and suitable to hold the magnet 516 in a fixed position within the device 500.

The coil 512 can be formed or structured so that all or a portion of the windings of the coil 512 are embedded in or integrated with the membrane 510. The coil 512 also can be formed or structured, and the magnet 516 can be positioned within the device 500, such that the windings of the coil can be within a defined distance of, and within the magnetic field generated by, the magnet 516. It is to be appreciated and understood that the coil 512 can comprise a defined number of windings having a desired arrangement, and FIGS. 5-7 depict, in a non-limiting manner, an example coil 512 having an example number of windings and an example coil arrangement for purposes of brevity and clarity. In accordance with the disclosed subject matter, there are a variety of different coils having different numbers of windings and/or different types of coil arrangements that can be employed to form a coil that can be used in the devices disclosed herein.

In response to receiving acoustic waves, for example, via the hole 506, the membrane 510 and associated coil 512 can vibrate or move in relation to the magnet 516 that is positioned within the hole 522 formed in the membrane 510. For instance, the membrane 510 and associated coil 512 can vibrate or move up and down with respect to the shaft of the magnet 516. In response to the coil 510 moving in relation to the shaft of the magnet 516, current in the coil 510 can vary through electromagnetic induction, and, in response to the varying current, electrical signals can be generated by the coil 510 that can correspond to the received acoustic waves. The device 500 can operate in a same or substantially same manner as the other devices (e.g., device 100, device 200, device 400) disclosed herein, in accordance with the disclosed subject matter.

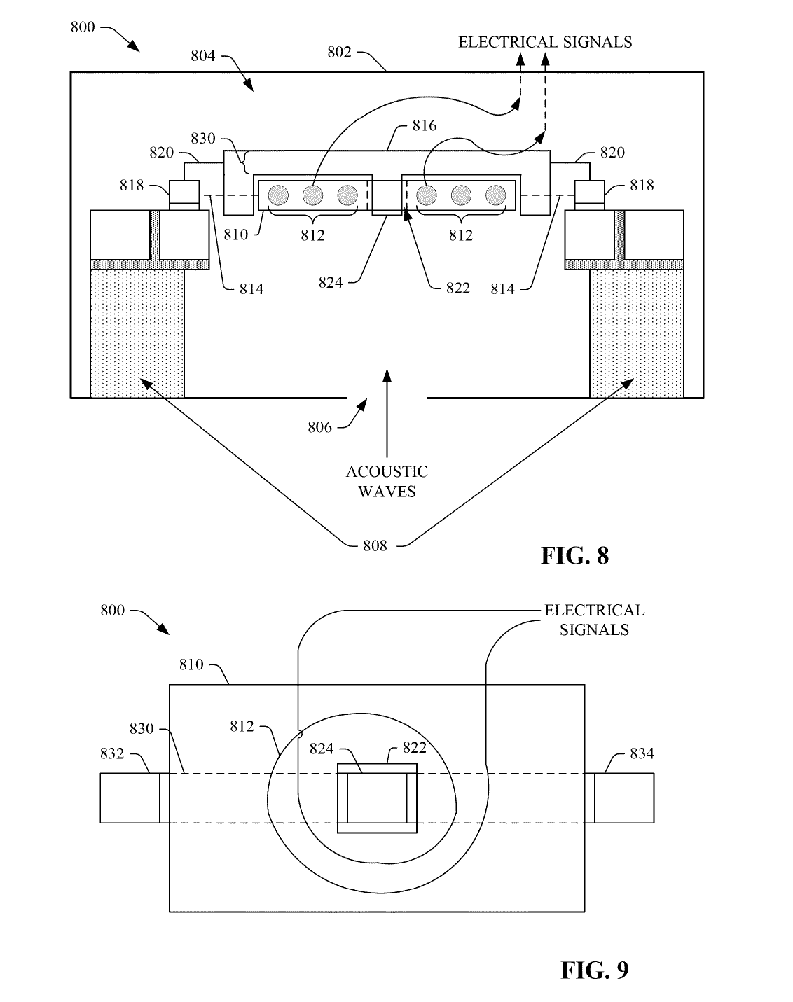

FIG. 8 depicts a diagram of a cross-sectional side-view of a portion of an example device 800 (e.g., a microphone), and FIG. 9 depicts a diagram of a top view of a portion of the example device 800, in accordance with various aspects and embodiments of the disclosed subject matter. The device 800 can comprise a casing 802, a cavity 804, a hole 806, a substrate 808, a membrane 810, a coil 812, a set of suspension components (e.g., springs) 814, a magnet component 816, a set of support components 818, and a set of magnet support components 820 that, respectively, can be the same as or similar to, and/or can comprise the same or similar features or functionalities as, respective components (e.g., respectively named components), as more fully disclosed herein. In some implementations, the membrane 810 can be or can comprise, for example, a MEMS membrane (e.g., an acoustic MEMS membrane), diaphragm, or sensor element, wherein the membrane 810 (and/or the associated coil 812) can be formed on the semiconductor chip or die using desired techniques (e.g., MEMS and/or desired semiconductor device fabrication techniques).

The device 800 (e.g., a MEMS microphone) can be substantially the same as the devices (e.g., device 100, device 200, device 400, device 500, or other device(s)) disclosed herein, except, for example, with respect to the following. The membrane 810 can be formed to comprise a hole 822 that can have a defined size and shape and can be in the middle (e.g., at or near the center) of the membrane 810 to facilitate enabling at least a magnet portion 824 of a first magnet section 826 and a second magnet section 828 of the magnet component 816 to be positioned within the hole 822 formed in the membrane 810 and surrounded by the coil 812 (e.g., surrounded by the windings of the coil 812). The defined size and shape of the hole 822 of the membrane 810, and the location of the hole 822 in the membrane 810, can correspond or at least substantially correspond with the defined size and shape of the magnet portion 824 and the location of the magnet portion 824 within the device 800. The membrane 810 can be formed such that there can be a desired space or gap between the edges of the hole 822 of the membrane 810 and the sides of the magnet portion 824 facing the respective edges of the hole 822 to facilitate enabling the membrane 810, and associated coil 812, to vibrate or move in relation to the magnet component 816 (e.g., including the magnet portion 824, first magnet section 826, and second magnet section 828), in response to acoustic waves received by the device 800, e.g., via the hole 806. It is to be appreciated and understood that the coil 812 can comprise a defined number of windings having a desired arrangement, and FIGS. 8 and 9 depict, in a non-limiting manner, an example coil 812 having an example number of windings and an example coil arrangement for purposes of brevity and clarity. In accordance with the disclosed subject matter, there are a variety of different coils having different numbers of windings and/or different types of coil arrangements that can be employed to form a coil that can be used in the devices disclosed herein.

The magnet component 816 (e.g., permanent magnet) can be fixed in position by the set of magnet support components 820, wherein each of the magnet support components 820 can have one end attached to the magnet component 816 and another end attached to the support components 818 (as depicted), the casing 802, or another portion(s) of the semiconductor die or the device 800, wherein the set of magnet support components 820 can be strong enough and suitable to hold the magnet component 816 in a fixed position within the device 800. The magnet component 816 also can comprise a base portion 830, wherein each of a first magnet portion 832 of the first magnet section 826, a second magnet portion 834 of the second magnet section 828, and the magnet section 824 can extend from the base portion 830 by a desired defined length. For example, the magnet section 824 can extend from the base portion 830 by a defined length such that the magnet section 824 can at least extend substantially from one side of the membrane 810 to the other side of the membrane 810 when the magnet section 824 is situated in the hole 822 and the membrane 810 is at rest (e.g., is not moving or being subjected to acoustic waves). An end of the first magnet section 826 can be adjoined to an end of the second magnet section 828. The first magnet section 826 can comprise respective opposite poles (e.g., a north pole, a south pole) at respective ends of the first magnet section 826, and the second magnet section 828 can comprise respective opposite poles (e.g., a north pole, a south pole) at respective ends of the second magnet section 828, wherein the end of the first magnet section 826 and the end of the second magnet section 828 that are adjoining can have opposite poles (e.g., the end of the first magnet section 826 can be a north pole, and the end of the second magnet section 828 can be a south pole).

In response to the device 800 receiving acoustic waves, for example, via the hole 806, the membrane 810 and associated coil 812 can vibrate or move in relation to the magnet component 816, including the magnet portion 824 that is positioned within the hole 822 formed in the membrane 810, and the first magnet portion 826 and second magnet portion 828. For instance, the membrane 810 and associated coil 812 can vibrate or move up and down with respect to the shaft of the magnet portion 824, and with respect to the first magnet portion 826, second magnet portion 828, and base portion 830. In response to the coil 810 moving in relation to the magnet component 816, current in the coil 810 can vary through electromagnetic induction. In response to the varying current, electrical signals can be generated by the coil 810 that can correspond to the received acoustic waves. The device 800 can operate in a same or substantially same manner as the other devices (e.g., device 100, device 200, device 400, device 500, or other devices) disclosed herein, in accordance with the disclosed subject matter.

It is to be appreciated that, while the device 800 is shown as having the magnet component 816 situated on the side of the membrane 810 that is facing the cavity 804, the disclosed subject matter is not so limited, as, in accordance with various other embodiments, the magnet component 816 can be situated within the device 800 to be on the other side of the membrane 810 that is facing the hole 806. In some implementations, a magnet component (e.g., magnet component 816, or other magnets or magnet components disclosed herein) can comprise a plurality of through-hole apertures that can be shaped, sized, and configured to achieve desirable (e.g., optimal, acceptable, suitable, usable) operation and performance of the device (e.g., device 800), wherein the through-hole apertures can facilitate enabling acoustic waves received by the device via the hole (e.g., hole 806) of the casing (e.g., casing 802) to reach and impact (e.g., cause to vibrate or move) the membrane (e.g., membrane 810) and associated coil (e.g., coil 812) to facilitate desirable operation and performance of the device.

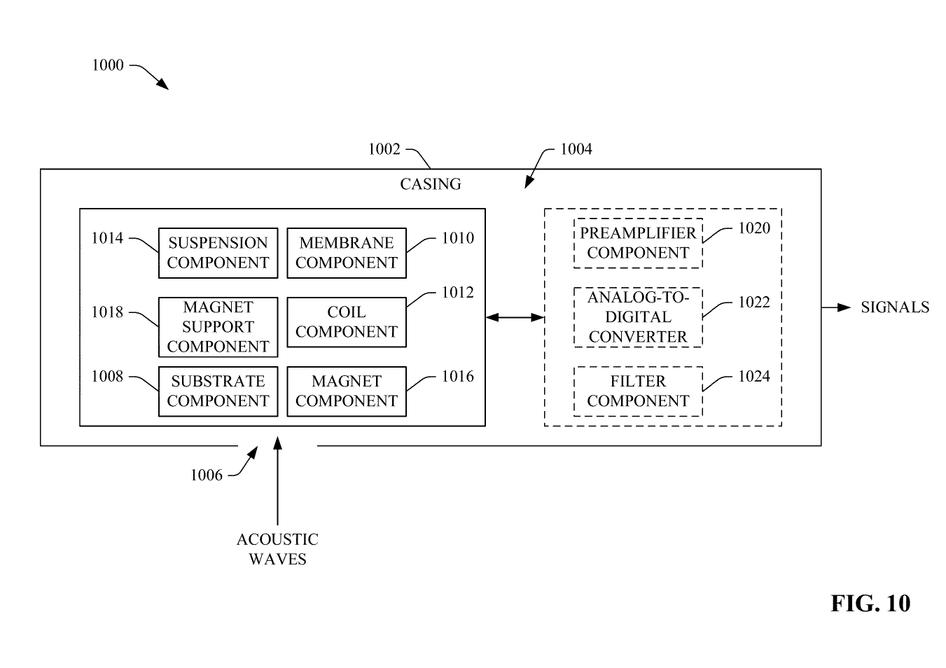

FIG. 10 illustrates a block diagram of still another example device 1000, in accordance with various aspects and embodiments of the disclosed subject matter. The device 1000 can comprise a casing 1002, a cavity 1004, a hole 1006, a substrate component 1008, a membrane component 1010, a coil component 1012, a suspension component 1014, a magnet component 1016, and a magnet support component 1018 that, respectively, can be the same as or similar to, and/or can comprise the same or similar features or functionalities as, respective components (e.g., respectively named components), as more fully disclosed herein. In some implementations, the membrane component 1010 can be or can comprise, for example, a MEMS membrane, diaphragm, or sensor element, wherein the membrane component 1010 (and/or the associated coil component 1012) can be formed on the semiconductor chip or die using desired techniques (e.g., MEMS and/or desired semiconductor device fabrication techniques.

In accordance with various implementations and embodiments, as desired, the device 1000 can comprise one or more other components, such as, for example, a preamplifier component 1020, an analog-to-digital converter 1022, or a filter component 1024, or such other components (e.g., the preamplifier component 1020, analog-to-digital converter 1022, or filter component 1024) can be situated external to the device 1000. It is to be appreciated and understood that, in FIG. 10, the depiction of the preamplifier component 1020, the analog-to-digital converter 1022, the filter component 1024, and the block within which they are depicted in FIG. 10, using a dotted line is intended to illustrate that the preamplifier component 1020, the analog-to-digital converter 1022, and the filter component 1024 can be contained within the device 1000 or can be situated external to the device 1000, as desired.

In some implementations, the device 1000 can comprise the preamplifier component 1020, which can be associated with the coil component 1012. In other implementations, the preamplifier component 1020 can be external to the device 1000 and can be associated with (e.g., connected to or in a signal path associated with) the coil component 1012. The preamplifier component 1020 can receive the electrical signals generated by the coil component 1012 in response to acoustic waves received by the device 1000, for example, via the hole 1006, such as more fully disclosed herein. The electrical signals can be raw or unprocessed signals (e.g., received from the coil component 1012) or partially processed signals (e.g., received from the filter component 1024). The preamplifier component 1020 can increase the electrical signals (e.g., microphone signals) received by the preamplifier component 1020 to a higher signal strength level (e.g., line level), which can be more suitable for transmitting the signals to other audio processing devices (e.g., a mixing board, an amplifier, an audio recording device), for example, via a wireline communication connection (e.g., a communication cable, such as a microphone cable) or wireless communication connection.

In certain implementations, the device 1000 can comprise the analog-to-digital component 1022, which can be associated with (e.g., connected to) the preamplifier component 1020 or filter component 1024. In other implementations, the analog-to-digital component 1022 can be external to the device 1000 and can be associated with (e.g., connected to or in a signal path associated with) the coil component 1012. The analog-to-digital component 1022 can receive the electrical signals (e.g., analog electrical signals) and can convert the analog electrical signals (e.g., corresponding to the audio waves) to digital signals for further processing in the digital domain, wherein the electrical signals can be unprocessed or processed (e.g., partially processed) electrical signals.

In still other implementations, the device 1000 can comprise the filter component 1024, which can filter signals (e.g., electrical signals, digital signals). The filter component 1024 can be associated with the coil component 1012, preamplifier component 1020, or the analog-to-digital component 1022. In yet other implementations, the filter component 1024 can be external to the device 1000 and can be associated with (e.g., connected to or in a signal path associated with) the coil component 1012. The filter component 1024 can comprise one or more analog filters (e.g., passive filters) that can filter, for example, the electrical signals to produce filtered signals, and/or one or more digital filters that that can filter, for example, the digital signals to produce filtered digital signals. The device 1000 can provide (e.g., transmit) the processed signals (e.g., processed electrical signals or digital signals) as an output, wherein the processed signals can be communicated to another audio processing device(s) (e.g., a mixing board, an amplifier, an audio recording device, a signal processor) for additional audio processing and/or presentation (e.g., broadcasting).

In contrast to conventional condenser microphones (e.g., conventional MEMS condenser microphones), in accordance with some implementations and embodiments of the disclosed subject matter, the device 1000 (e.g., a MEMS microphone) can operate suitably without consuming or needing power, and it is not necessary for such device 1000 to have a charge pump (e.g., on the semiconductor device) or other external power source in order for the device 1000 to operate in a desirable or suitable manner. For example, if the device 1000 does not include the preamplifier component 1020, the analog-to-digital component 1022, and the filter component 1024, or if the device 1000 does not include the preamplifier component 1020 and the analog-to-digital component 1022, and only includes a filter component 1024 that employs a passive filter (with no digital or active filter), the device 1000 can operate suitably without consuming or needing power, and it is not necessary for such device 1000 to have a charge pump or other external power source in order for the device 1000 to operate in a desirable or suitable manner. In other implementations of the disclosed subject matter that include the preamplifier component 1020, the analog-to-digital component 1022, or a filter component 1024 that employs a digital or an active filter, the device 1000 still can operate desirably or suitably, while consuming less power than conventional condenser microphones, due in part to the power-free operation associated with the magnet component 1016 and the membrane and coil structure (e.g., the membrane component 1010 and associated coil component 1012), even though such preamplifier component 1020, analog-to-digital converter component 1022, or active or digital filter of the filter component 1024, or may require a certain amount of power for operation.

In accordance with various embodiments of the disclosed subject matter, the devices (e.g., microphones, such as MEMS microphones), and/or other components, can be situated or implemented on a single IC die or chip. An IC chip can be a CMOS chip, for example. In accordance with various other embodiments, the devices, and/or other components, can be implemented on an ASIC chip. In accordance with still other embodiments, the devices, and/or other components, can be situated or implemented on multiple IC dies or chips.

The aforementioned devices and/or systems have been described with respect to interaction between several components. It should be appreciated that such systems and components can include those components or sub-components specified therein, some of the specified components or sub-components, and/or additional components. Sub-components could also be implemented as components coupled to and/or communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

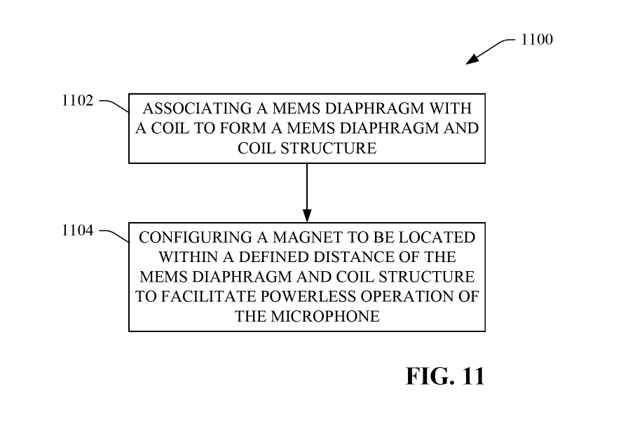

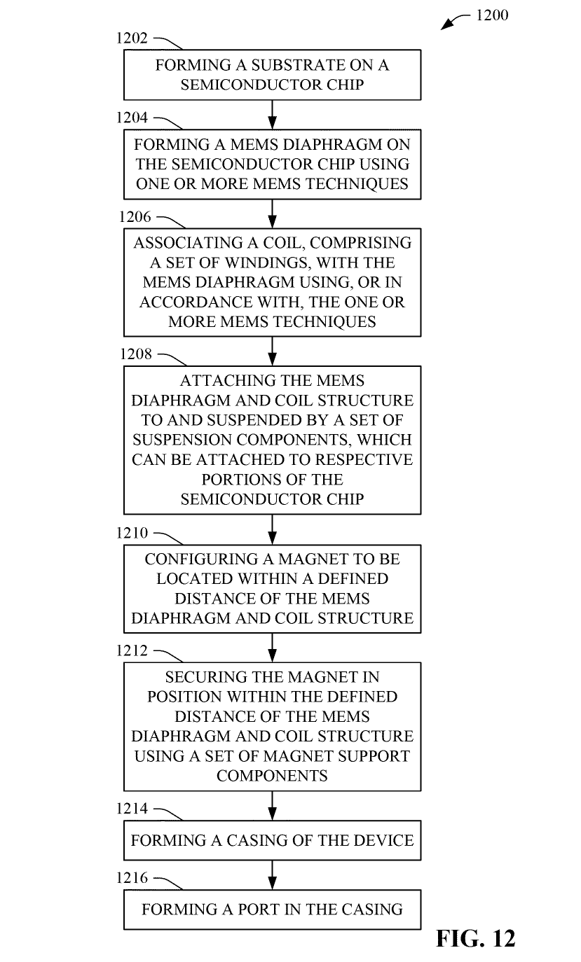

FIGS. 11-12 illustrate methods and/or flow diagrams in accordance with the disclosed subject matter. For simplicity of explanation, the methods are depicted and described as a series of acts. It is to be understood and appreciated that the subject disclosure is not limited by the acts illustrated and/or by the order of acts, for example acts can occur in various orders and/or concurrently, and with other acts not presented and described herein. Furthermore, not all illustrated acts may be required to implement the methods in accordance with the disclosed subject matter.

Referring to FIG. 11, illustrated is a flow diagram of an example method 1100 for constructing a microphone (e.g., MEMS microphone) that can operate while consuming no power, in accordance with various aspects and embodiments of the disclosed subject matter.

At 1102, a MEMS diaphragm can be associated with a coil to form a MEMS diaphragm and coil structure. The MEMS diaphragm (e.g. MEMS membrane or sensor element) can be formed, for example, on a semiconductor chip using one or more MEMS techniques (e.g., one or more MEMS or CMOS MEMS semiconductor fabrication processes). During the fabrication process, the coil (e.g., induction coil), which can comprise a set of windings, or a portion of the coil, can be embedded in, integrated with, connected to, attached to, structured to be included with, and/or otherwise associated with the MEMS diaphragm to form the MEMS diaphragm and coil structure.

At 1104, a magnet can be configured to be located within a defined distance of the MEMS diaphragm and coil structure to facilitate powerless operation of the microphone. The magnet can generate a magnetic field and the coil can be located within the magnetic field. In response to acoustic waves received by the microphone via a port (e.g., a hole) in the microphone casing and sensed by the MEMS diaphragm, the MEMS diaphragm can vibrate in a manner that can correspond to the acoustic waves. In response to the vibration (e.g., movement) of the MEMS diaphragm, the coil can vibrate or move in relation to the magnet resulting in the generation of electrical signals that can correspond to the acoustic waves.

Turning to FIG. 12, depicted is a flow diagram of another example method 1200 for constructing a microphone (e.g., MEMS microphone) that can operate while consuming no power, in accordance with various aspects and embodiments of the disclosed subject matter.

At 1202, a substrate can be formed on a semiconductor chip. At 1204, a MEMS diaphragm can be formed on the semiconductor chip using one or more MEMS techniques. The diaphragm can have a desired defined length, width, and thickness.

At 1206, a coil, comprising a set of windings, can be associated with (e.g., embedded in, integrated with, attached to) the MEMS diaphragm to form a MEMS diaphragm and coil structure using, or in accordance with, the one or more MEMS techniques. At 1208, the MEMS diaphragm and coil structure can be attached to and suspended by a set of suspension components (e.g., springs), which can be attached to respective portions of the semiconductor chip.

At 1210, a magnet can be configured to be located within a defined distance of the MEMS diaphragm and coil structure. The defined distance can be based at least in part on the area covered or subject to a magnetic field that can be generated by the magnet (e.g., permanent magnet). At 1212, the magnet can be secured in position within the defined distance of the MEMS diaphragm and coil structure using a set of magnet support components that can be attached to the magnet on one of their ends and attached to a desired portion (e.g., component) of the microphone device (e.g., the casing, respective portions (e.g., pads) of the semiconductor device, or other component(s)) on the other of their ends. The coil can be structured to surround the magnet and be within the range of the magnetic field generated by the magnet. In some implementations, the diaphragm can comprise one or more holes to accommodate one or more magnets that can be inserted or positioned within the one or more holes and surrounded by the windings of the coil.

At 1214, a casing of the device can be formed. The casing for the device (e.g., microphone) can be formed of one or more desired materials (e.g., plastic, metal). The casing can enclose, or at least substantially enclose, various components (e.g., substrate, MEMS diaphragm, coil, magnet, suspension components, magnet support components) of the semiconductor device or microphone. At 1216, a port (e.g., one or more holes) can be formed in the casing. The port can be formed in the casing in an area proximate to the MEMS diaphragm to facilitate enabling acoustic waves to enter the casing and impact the diaphragm, wherein the MEMS diaphragm can sense acoustic waves that are received by the microphone, for example, via the port. The MEMS microphone can operate to convert received acoustic waves to electrical signals without consuming power (e.g., without the need for power from a charge pump or other power source), as more fully disclosed herein.

It is to be appreciated and understood that components (e.g., casing, substrate, membrane, coil, magnet, spring, suspension component, support component, magnet support component), as described with regard to a particular device, system, or method, can include the same or similar functionality as respective components (e.g., respectively named components or similarly named components) as described with regard to other devices, systems, or methods disclosed herein.

Although the description has been provided with respect to particular embodiments thereof, these particular embodiments are merely illustrative and not restrictive.

As used herein, the term “top”, “bottom”, “left”, and “right” are relative and merely examples of the structures disclosed. It is understood that the relation of the structures may be opposite to that which is stated. For example, the term “bottom”, as used herein, may be “top” in other embodiments of the subject disclosure.

The articles “a,” “an,” and “the” as used in the subject specification and annexed drawings should generally be construed to mean “one or more” unless specified otherwise or clear from context to be directed to a singular form. Thus, as used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise. In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

What has been described above includes examples of aspects of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has,” or “having,” or variations thereof, are used in either the detailed description or the claims, such terms are intended to be inclusive in a manner similar to the term “comprising” as “comprising” is interpreted when employed as a transitional word in a claim.

What is claimed is:

1. A device, comprising:
a microelectrical-mechanical systems (MEMS) membrane;
a coil associated with the MEMS membrane; and
a magnet configured to be located in proximity to the MEMS membrane and the coil, wherein the magnet is configured to generate a magnetic field and the coil is located within the magnetic field, and wherein acoustic waves received by the device cause the MEMS membrane to vibrate, accordingly causing the coil to move in relation to the magnet resulting in generation of electrical signals that correspond to the acoustic waves.

2. The device of claim 1, wherein the device is configured to operate to generate the electrical signals without consuming power, in response to receipt of the acoustic waves.

3. The device of claim 1, wherein the magnet is configured to be a permanent magnet that retains its magnetic properties in the absence of an inducing field or current.

4. The device of claim 1, further comprising:
a package that encases the MEMS membrane, the coil, and the magnet; and
a port configured to receive the acoustic waves, wherein the port is formed in the package and has a defined size and a defined shape.

5. The device of claim 1, wherein at least a portion of the coil is configured to be embedded in the MEMS membrane.

6. The device of claim 1, wherein the MEMS membrane is formed using a MEMS technique.

7. The device of claim 1, wherein the MEMS membrane is further configured to comprise a hole of a defined size and a defined shape, and the magnet is further configured to have a portion of the magnet situated in the device to have the portion of the magnet within the hole of the MEMS membrane.

8. The device of claim 7, wherein the magnet is further configured to comprise a first magnet section and a second magnet section, wherein the first magnet section is in proximity to a first portion of the MEMS membrane and a first portion of the coil, and the second magnet section is in proximity to a second portion of the MEMS membrane and a second portion of the coil.

9. The device of claim 8, wherein each of the first magnet section and the second magnet section comprise a first pole and a second pole that is opposite in polarity to the first pole, and wherein the first pole of the first magnet section adjoins the second pole of the second magnet section in the magnet.

10. The device of claim 1, wherein the coil comprises a set of windings that surround the magnet.

11. The device of claim 10, wherein the set of windings comprises a first winding and a last winding, and the first winding is in closer proximity to a first pole of the magnet than the last winding, and the last winding is in closer proximity to a second pole of the magnet than the first winding.

12. The device of claim 1, wherein the device comprises a MEMS microphone comprising the MEMS membrane, the coil, and the magnet.

13. A method, comprising:
associating a microelectrical-mechanical systems (MEMS) diaphragm with a coil; and
configuring a magnet to be located within a defined distance of the MEMS diaphragm and the coil, wherein the magnet generates a magnetic field and the coil is located within the magnetic field, and wherein, in response to acoustic waves sensed by the MEMS diaphragm, the MEMS diaphragm vibrates, and, in response to the vibration of the MEMS diaphragm, the coil moves in relation to the magnet resulting in generating of electrical signals that correspond to the acoustic waves.

14. The method of claim 13, wherein the generating of the electrical signals further comprises generating the electrical signals, in response to receiving the acoustic waves, without consuming power, based at least in part on a current in the coil varying in response to the moving of the coil in relation to the magnet.

15. The method of claim 13, wherein the associating the MEMS diaphragm with the coil further comprises integrating the coil with the MEMS diaphragm.

16. The method of claim 13, further comprising:
receiving the acoustic waves via an acoustic port that comprises at least one hole of a defined size and a defined shape formed in a casing of a device that comprises the MEMS diaphragm, the coil, and the magnet.

17. The method of claim 13, further comprising forming the MEMS diaphragm using a MEMS technique.

18. The method of claim 13, further comprising:
forming a hole of a defined size and a defined shape in the MEMS diaphragm; and
configuring the magnet to have a portion of the magnet situated within the hole of the MEMS membrane.

19. The method of claim 18, further comprising:
forming the magnet to comprise a first magnet section and a second magnet section;
configuring the first magnet section to be in proximity to a first portion of the MEMS diaphragm and a first portion of the coil; and
configuring the second magnet section to be in proximity to a second portion of the MEMS diaphragm and a second portion of the coil.

20. The method of claim 13, further comprising:
forming the coil to comprise a set of windings that comprise a first winding and a last winding; and
configuring the set of windings to surround the magnet, to have the first winding be in closer proximity to a first pole of the magnet than the last winding, and to have the last winding be in closer proximity to a second pole of the magnet than the first winding.

21. An integrated circuit chip, comprising:
a microelectrical-mechanical systems (MEMS) sensor element;
a coil component associated with the MEMS sensor element; and
a magnet component that is located in proximity to the MEMS sensor element and the coil component, wherein the magnet component generates a magnetic field and the coil component is located within the magnetic field, and wherein the MEMS sensor element moves in response to audio waves received by a device comprising the integrated circuit chip, and, in response to the movement of the MEMS sensor element, the coil moves in relation to the magnet resulting in generation of electrical signals that correspond to the audio waves.

22. The integrated circuit chip of claim 21, wherein the MEMS sensor element, the coil component, and the magnet component operate to facilitate generation of the electrical signals, in response to receipt of the audio waves, without consuming power.

23. The integrated circuit chip of claim 21, wherein the MEMS sensor element is formed, and at least a portion of the coil is configured to be embedded in the MEMS sensor element, using one or more MEMS techniques, and wherein the coil comprises a set of windings that surround at least a portion of the magnet component.
